(19) United States
(12) Patent Application Publication
(10) Pub. No.: US 2025/0078394 A1
(43) Pub. Date: Mar. 6, 2025

(54) RENDERING METHOD AND DEVICE

(71) Applicant: SAMSUNG ELECTRONICS CO., LTD., Suwon-si (KR)

(72) Inventors: Seokhwan JANG, Suwon-si (KR); Minjung SON, Suwon-si (KR); Sungheon PARK, Suwon-si (KR); Young Chun AHN, Suwon-si (KR); Nahyup KANG, Suwon-si (KR); Jiyeon KIM, Suwon-si (KR)

(73) Assignee: SAMSUNG ELECTRONICS CO., LTD., Suwon-si (KR)

(21) Appl. No.: 18/666,433

(22) Filed: May 16, 2024

(30) Foreign Application Priority Data
Aug. 28, 2023 (KR) 10-2023-0112999

(51) Int. Cl. G06T 15/20; G06T 3/18

(52) U.S. Cl. CPC G06T 15/205; G06T 3/18

(57) ABSTRACT

A rendering method and rendering device are provided. The rendering method includes obtaining a target image corresponding to a target view by inputting parameter information corresponding to the target view to a neural scene representation (NSR) model, determining an adjacent view that satisfies a predetermined condition with respect to the target view, obtaining an adjacent image corresponding to the adjacent view by inputting parameter information corresponding to the adjacent view to the NSR model, and obtaining a final image by correcting the target image based on the adjacent image.

### CROSS-REFERENCE TO RELATED APPLICATION

This application claims priority from Korean Patent Application No. 10-2023-0112999, filed on Aug. 28, 2023, in the Korean Intellectual Property Office, the entire disclosure of which is incorporated herein by reference for all purposes.

### BACKGROUND

### 1. Field

The disclosure relates to methods and apparatuses for rendering an image, and more particularly, to a method and an apparatus for rendering an image based on image warping.

### 2. Description of Related Art

Three-dimensional (3D) rendering is a field of computer graphics that renders a 3D scene into a two-dimensional (2D) image. 3D rendering may be used in various application fields, such as 3D games, virtual reality, animation, movies, and the like. Neural rendering may include technology that converts a 3D scene into a 2D output image using a neural network. The neural network may be trained based on deep learning and may subsequently perform an inference by mapping input data to output data in a non-linear relationship with each other. The trained ability to generate such mapping may be referred to as a learning ability of the neural network. The neural network may observe a real scene and learn a method of modeling and rendering the scene.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, there is provided a rendering method including: obtaining a target image corresponding to a target view based on by inputting first parameter information corresponding to the target view to a neural scene representation (NSR) model; obtaining an adjacent view that satisfies a predetermined condition with respect to the target view; obtaining an adjacent image corresponding to the adjacent view by inputting second parameter information corresponding to the adjacent view to the NSR model; and obtaining a final image by correcting the target image based on the adjacent image.

The obtaining the final image may include: detecting an occlusion area in the target image; and correcting the occlusion area in the target image based on the adjacent image.

The obtaining the final image may include: obtaining a visibility map based on the target image and the adjacent image; and correcting the target image based on the visibility map.

The obtaining the visibility map may include: obtaining a first warped image by backward-warping the adjacent image to the target view; and obtaining the visibility map based on a difference between the first warped image and the target image.

The obtaining the visibility map based on the difference may include: obtaining a visibility value for a first pixel of the first warped image based on a difference between the first pixel of the first warped image and a second pixel of the target image corresponding to the first pixel.

The correcting the target image may include: detecting an occlusion area in the target image based on the visibility map; and correcting the occlusion area in the target image based on the adjacent image.

The detecting the occlusion area may include: detecting an occluded pixel having a visibility value that is greater than or equal to a threshold value in the target image.

The correcting the occlusion area may include: replacing the occluded pixel in the target image with a pixel of the adjacent image corresponding to a position of the occluded pixel.

The obtaining the adjacent view may include: obtaining a plurality of adjacent views corresponding to the target view, the obtaining of the adjacent image may include: obtaining a plurality of adjacent images, each of the plurality of adjacent images corresponding to one of the plurality of adjacent views, and the correcting of the occlusion area may include: obtaining a pixel of each of the plurality of adjacent images corresponding to a position of the occluded pixel in the target image; and correcting the occluded pixel in the target image based on the pixel of each of the plurality of adjacent images.

The obtaining the adjacent view may include: obtaining the adjacent view by sampling views within a preset camera rotation angle based on the target view.

The obtaining the target image may include: obtaining a rendered image corresponding to the target view and a depth map corresponding to the target view.

The obtaining the adjacent image may include: obtaining a rendered image corresponding to the adjacent view and a depth map corresponding to the adjacent view.

According to another aspect of the disclosure, there is provided a non-transitory computer-readable storage medium storing instructions that, when executed by a processor, cause the processor to perform a method including: obtaining a target image corresponding to a target view by inputting first parameter information corresponding to the target view to a neural scene representation (NSR) model; obtaining an adjacent view corresponding to the target view; obtaining an adjacent image corresponding to the adjacent view by inputting second parameter information corresponding to the adjacent view to the NSR model; and obtaining a final image by correcting the target image based on the adjacent image.

According to another aspect of the disclosure, there is provided a rendering device including: a memory configured to store instructions, at least one processor configured to execute the instructions to: obtain a target image corresponding to a target view by inputting first parameter information corresponding to the target view to a neural scene representation (NSR) model; obtain an adjacent view that satisfies a predetermined condition with respect to the target view; obtain an adjacent image corresponding to the adjacent view by inputting second parameter information corresponding to the adjacent view to the NSR model; and obtain a final image by correcting the target image based on the adjacent image.

The at least one processor may be further configured to execute the instructions to: detect an occlusion area in the target image; and correct the occlusion area in the target image based on the adjacent image.

The at least one processor may be further configured to execute the instructions to obtain a visibility map based on the target image and the adjacent image; and correct the target image based on the visibility map.

The at least one processor may be further configured to execute the instructions to obtain a first warped image by backward-warping the adjacent image to the target view; and obtain the visibility map based on a difference between the first warped image and the target image.

The at least one processor may be further configured to execute the instructions to detect an occlusion area in the target image based on the visibility map; and correct the occlusion area in the target image based on the adjacent image.

The at least one processor may be further configured to execute the instructions to detect an occluded pixel having a visibility value that is greater than or equal to a threshold value in the target image.

The at least one processor may be further configured to execute the instructions to replace the occluded pixel in the target image with a pixel of the adjacent image corresponding to a position of the occluded pixel.

Additional aspects of embodiments will be set forth in part in the description which follows and, in part, will be apparent from the description, or may be learned by practice of the disclosure.

### BRIEF DESCRIPTION OF DRAWINGS

The above and/or other aspects will be more apparent by describing certain embodiments with reference to the accompanying drawings, in which:

FIG. 1 is a diagram illustrating an example of neural scene representation (NSR) according to an embodiment;

FIG. 2 is a diagram illustrating a volume-rendering method according to an embodiment;

FIG. 3 is a diagram illustrating an occlusion area according to an embodiment;

FIG. 4 is a diagram illustrating a method of training an NSR model, according to an embodiment;

FIGS. 5A and 5B are diagrams illustrating a rendering method according to an embodiment;

FIG. 6 is a diagram illustrating a method of training an NSR model, according to another embodiment;

FIG. 7 is a flowchart illustrating a rendering method according to an embodiment;

FIG. 8 is a block diagram illustrating an example of a configuration of a rendering device according to an embodiment; and

FIG. 9 is a block diagram illustrating an example of a configuration of an electronic device, according to an embodiment.

### DETAILED DESCRIPTION

The following descriptions of embodiments provided in the disclosure are merely intended for the purpose of describing the examples and the examples may be implemented in various forms. The embodiments are not meant to be limited, but it is intended that various modifications, equivalents, and alternatives are also covered within the scope of the claims.

Although terms such as “first” or “second” are used to explain various components, the components are not limited to the terms. These terms should be used only to distinguish one component from another component. For example, a first component may be referred to as a second component, and similarly the second component may also be referred to as the first component.

It should be noted that if one component is described as being “connected,” “coupled,” or “joined” to another component, the first component may be directly connected, coupled, or joined to the second component, or a third component may be “connected,” “coupled,” or “joined” between the first and second components. On the contrary, it should be noted that if it is described that one component is “directly connected,” “directly coupled,” or “directly joined” to another component, a third component may be absent. Expressions describing a relationship between components, for example, “between,” directly between,” or “directly neighboring,” etc., should be interpreted the same as the above.

The singular forms “a,” “an,” and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical and scientific terms used herein have the same meaning as those commonly understood by one of ordinary skill in the art to which the disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

The examples may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, examples are described in detail with reference to the accompanying drawings. In the drawings, like reference numerals are used for like elements.

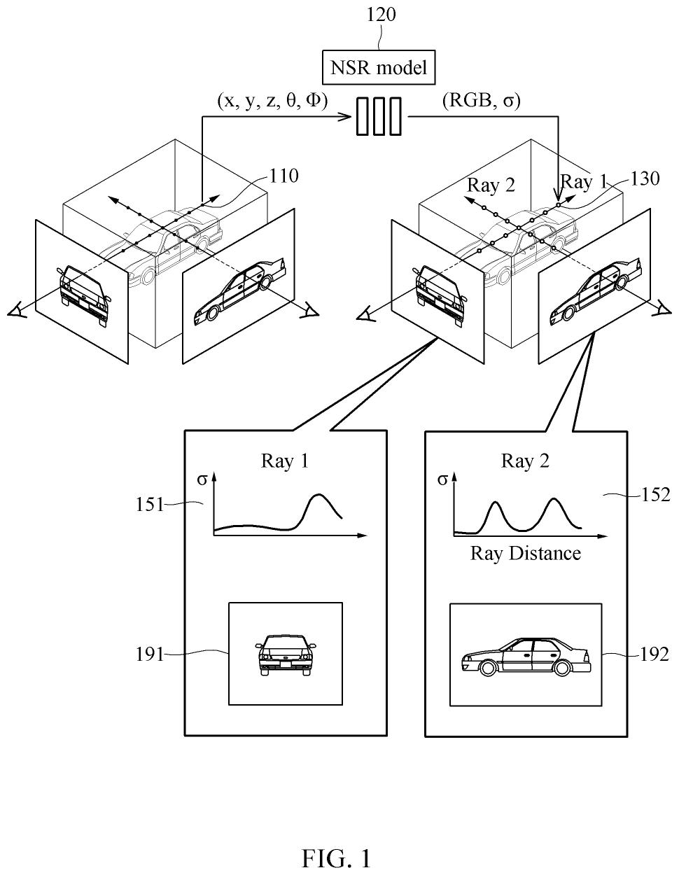

FIG. 1 is a diagram illustrating an example of neural scene representation (NSR) according to an embodiment.

According to an embodiment, a scene of a three-dimensional (3D) space may be represented as NSR using points in the 3D space. FIG. 1 illustrates an example of deriving, from a query input 110 specifying a point in the 3D space, NSR data 130 corresponding to the point. An NSR model 120 may output the NSR data 130 based on an input of the query input 110. The NSR model 120 may be a module designed and trained to output the NSR data 130 from the query input 110. The NSR model 120 may include, for example, a neural network.

The query input 110 may include location information in the 3D space and direction information corresponding to a view direction. For example, the query input 110 for each point may include coordinates representing a corresponding point in the 3D space and a direction of a view direction. The view direction may represent a direction passing through a pixel and/or points corresponding to the pixel from a view facing a two-dimensional (2D) scene to be synthesized and/or restored. As illustrated in FIG. 1, the direction may be Ray 1 or Ray 2. However, the disclosure is not limited thereto, and as such, the number of view direction may be different than two. In FIG. 1, as an example of the query input 110, the coordinates of (x, y, z) and direction information of (θ, ϕ) may be shown. Here, (x, y, z) may be coordinates according to the Cartesian coordinate system based on an origin point, and (θ, ϕ) may be angles formed between the view direction and two reference axes. For example, the two references axes may be the positive direction of the z-axis and the positive direction of the x-axis. According to an embodiment, the origin point may be a predetermined point and the two reference axes may be predetermined axes. Hereinafter, the query input 110 may be referred to as parameter information corresponding to a target view.

The NSR data 130 may be data representing scenes of the 3D space viewed from several view directions, and may include, for example, neural radiance field (NeRF) data. The NSR data 130 may include color information and volume densities 151 and 152 of the 3D space for each point and for each view direction. The color information may include color values according to a color space. For example, the color space may be an RGB color space, and in which case, the color values may be a red value, a green value, and a blue value. However, the disclosure is not limited thereto, and as such, the color space may be a different type. The volume densities 151 and 152, referred to as ‘σ’, of a predetermined point may be interpreted as the possibility (e.g., differential probability) that a ray ends at an infinitesimal particle of the corresponding point. In the graphs of the volume densities 151 and 152 shown in FIG. 1, the horizontal axis may denote a ray distance spaced from a view in a view direction, and the vertical axis may denote the value of the volume density according to each ray distance. A color value (e.g., an RGB value) may also be determined according to the ray distance spaced from a view in the view direction. However, the NSR data 130 is not limited to the above description and may vary according to design.

The NSR model 120 (e.g., a neural network) may learn the NSR data 130 corresponding to 3D scene information through deep learning. An image of a specific view specified by the query input 110 may be rendered by outputting the NSR data 130 from the NSR model 120 through the query input 110. The NSR model 120 may include a multi-layer perceptron (MLP)-based neural network. For the query input 110 of (x, y, z, θ, ϕ) specifying a point of a ray, the neural network may be trained to output the color values (e.g., an RGB value) and the volume density (σ) of the corresponding point. For example, a view direction may be defined for each pixel of 2D scene images 191 and 192, and output values (e.g., the NSR data 130) of all sample points in the view direction may be obtained through a neural network operation. For example, the output values of all the sample points in the view direction may be calculated through a neural network operation. In FIG. 1, the 2D scene image 191 of a vehicle object viewed from the front and the 2D scene image 192 of the vehicle object viewed from the side are shown.

In order for the NSR model 120 to learn the 3D scene to render a 2D scene for any arbitrary view, a large volume of training images of various views for a 3D scene may be required. However, securing the large volume of training images through actual shooting may be difficult.

To solve this issue, multiple augmentation training images of various new views may be derived from a few of original training images of base views through data augmentation based on image warping.

However, in an example case of using image warping, an occlusion area may need to be considered. The occlusion area may refer to an area that is observed from one view but is not observed from another view. During image warping, a large warping error may occur due to the occlusion area. Embodiments of the disclosure may perform image warping by taking the occlusion area into consideration.

Furthermore, as explained in detail below, in an example case of rendering an image using the trained NSR model 120, embodiments may correct a position with poor image quality in a rendered image of the target view, and thus improve the image quality using a rendered image of an adjacent view based on the rendered image of the target view.

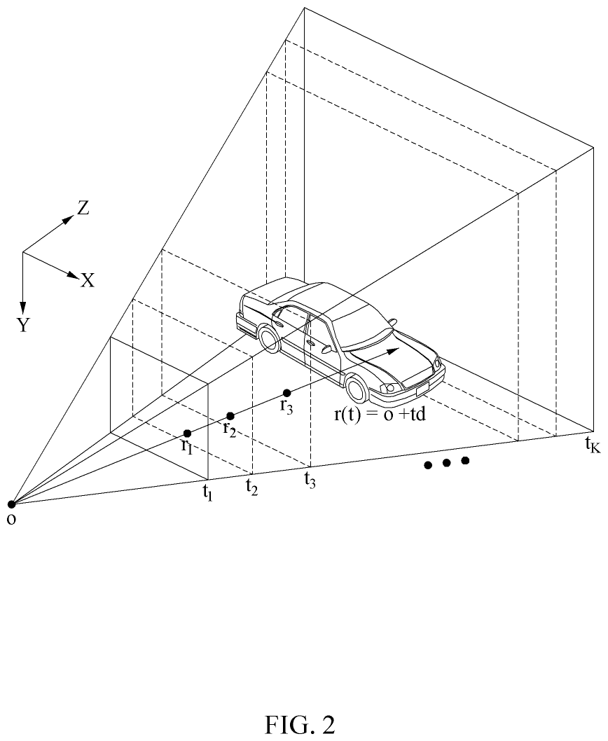

FIG. 2 is a diagram illustrating a volume-rendering method according to an embodiment. The description provided with reference to FIG. 1 may also apply to FIG. 2.

Referring to FIG. 2, a scene may be trained on an artificial neural network (ANN) model (e.g., the NSR model 120 of FIG. 1). More specifically, in an example case of training the ANN model using images captured from discontinuous views, the ANN model may learn the scene itself and represent a new random view which has not been trained using a training dataset.

A ray ‘r’ may be defined for a pixel position of an image, and a ray may be a straight line generated when viewing a 3D object from a certain viewpoint (e.g., a position of a camera). Sampling data may be obtained by sampling points on the ray. Hereinafter, the sampling data may also be referred to as a sampling point or a 3D point.

The points on the ray may be sampled a predetermined number of times at a predetermined interval. For example, the points on the ray may be sampled k times at regular intervals, and a total of K 3D positions from x1 to xK may be obtained.

The ANN model may receive spatial information of the sampling data. The spatial information of the sampling data may include spatial information of the ray and sampling information. The spatial information of the ray may include a 2D parameter (θ, ϕ) indicating a direction of the ray. The sampling information may include 3D position information (x, y, z) of the sampling data. The spatial information of the sampling data may be represented by 5D coordinates (x, y, z, θ, ϕ).

The ANN model may receive the spatial information of the sampling data and output a volume density σ and a color value c of the position of the sampling data as a result value.

In an example case in which inference is performed on all pieces of sampling data that are sampled on the ray, a color value of a pixel position corresponding to the sampling data may be calculated according to Equation 1 below.

$$C ( r ) = {\sum }_{k} {T}_{k} ( 1 - exp ( σ ( {r}_{k} ) δ ( {r}_{k} ) ) c ( {r}_{k} ) , where {T}_{k} = exp ( - {\sum }_{l = 1}^{k - 1} σ ( {r}_{l} ) δ ( {r}_{l} ) ) \qquad [ Equation 1 ]$$

Inference may be performed for all pixel positions to obtain a 2D RGB image of a random view. In Equation 1, a transmittance Tₖ may be calculated for a current position k, and a volume density of the current position k may be determined. In an example case of using a multiplication of the transmittance Tₖ by the volume density of the current position k as a weight, a pixel color value may be, for example, a weighted sum performed along the ray, which is represented as Equation 2 below.

$$C ( r ) = {\sum }_{k} {w}_{k} {c}_{k} , where {w}_{k} = {T}_{k} ( 1 - exp ( σ ( {r}_{k} ) δ ( {r}_{k} ) ) {c}_{k} = c ( {r}_{k} ) \qquad [ Equation 2 ]$$

Referring to Equation 2, a color value may be determined based on the distribution of weights of each ray. In an example case of training through the above-described method is completed, an RGB image of a desired view may be rendered.

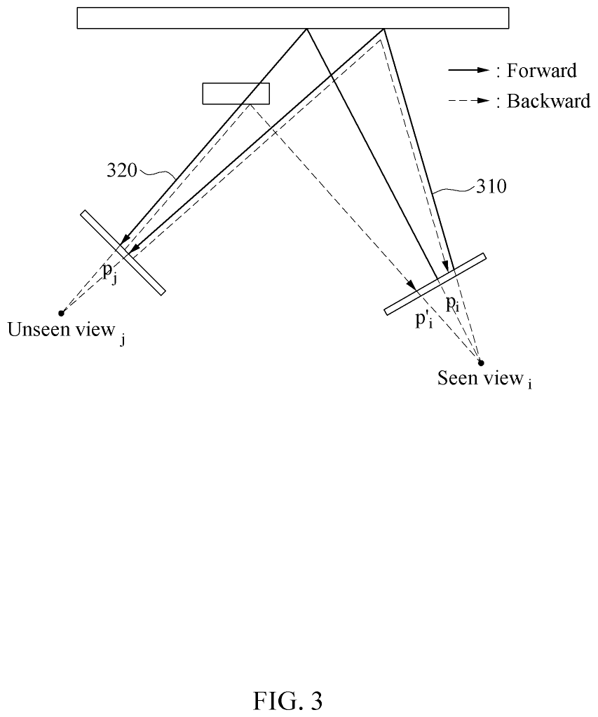

FIG. 3 is a diagram illustrating an occlusion area according to an embodiment. The description provided with reference to FIGS. 1 and 2 may also apply to FIG. 3.

Referring to FIG. 3, in a scenario 310 in which an occlusion area does not exist, a forward-warping or a backward-warping may be performed. For example, in an example case of forward-warping from a currently known view (seen view), which is a source view, to an unknown view (unseen view), which is a desired view (hereinafter, referred to as a target view), a random pixel position pᵢ of the source view may be mapped to a position pⱼ of the target view. Moreover, in an example case of backward-warping from the target view to the source view, the position pⱼ of the target view may be mapped back to the position pᵢ of the source view.

However, in a scenario 320 in which an occlusion area exists in an image, in a case of forward-warping from the source view to the target view, the position pᵢ of the source view may be mapped to the position pⱼ of the target view as in the above case. However, in a case of backward-warping from the target view to the source view, the position pⱼ of the target view may not be mapped to the position pᵢ of the source view; instead the position pⱼ of the target view may be mapped to a position pᵢ′ due to the occlusion area. In other words, in the scenario 320 in which an occlusion area exists in an image, the two pixel positions may be significantly different when forward warping is performed again after backward warping.

According to an embodiment, a rendering device may use a visibility map to reflect a warping error that may occur due to an occlusion area when performing warping. The visibility map may be determined based on the distance value between two pixel positions after sequentially performing backward warping and forward warping for two random views.

For example, the visibility map may be defined so that the probability of the area being an occlusion area increases as the distance between the two pixel positions increases and the probability of the area being an occlusion area decreases as the distance between the two pixel positions decreases. For example, the visibility map may be defined as shown in Equation 3.

$$v ( r ) = exp ( - \frac{‖ {p}_{i} - {p}_{i}^{′} ‖}{2 {σ}^{2}} ) \qquad [ Equation 3 ]$$

In Equation 3, p denotes the pixel position in the image of a ray defined as r, and σ is a hyperparameter that controls a visibility value for the distance between the two pixel positions. However, the visibility map may be implemented in various forms. Equation 3 is only one of many examples, and embodiments are not limited thereto.

Furthermore, the position pⱼ of the target view may be calculated as shown in Equation 4, and the position pᵢ of the source view may be calculated as shown in Equation 5.

$${p}_{j} ∼ {KT}_{i \to j} D ( {p}_{i} ) {K}^{- 1} {p}_{i} \qquad [ Equation 4 ]$$

$${p}_{i}^{′} ∼ {KT}_{j \to i} \hat{D} ( {p}_{j} ) {K}^{- 1} {p}_{j} \qquad [ Equation 5 ]$$

In Equations 4 and 5, K may denote an intrinsic matrix, D may denote a depth map of the target view, \hat{D} may denote a depth map of the source view, and T may denote a view transformation matrix. Moreover, K⁻¹ may denote an inverse matrix of K and D(p) may denote a depth value of a pixel value p. The rendering device may calculate the visibility map according to Equations 3 to 5.

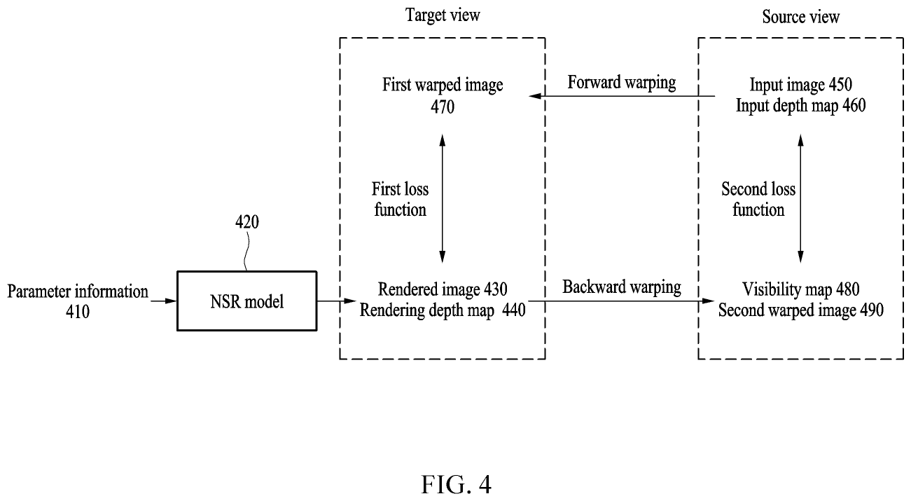

FIG. 4 is a diagram illustrating a method of training an NSR model, according to an embodiment. The description provided with reference to FIGS. 1 to 3 may also apply to FIG. 4.

Referring to FIG. 4, an NSR model 420 (e.g., the NSR model 120 of FIG. 1) according to an embodiment may be trained to output a rendered image 430 and/or a rendering depth map 440 of a corresponding point for parameter information 410 (e.g., the query input 110 of FIG. 1). A first loss function may be determined based on the difference between a first warped image 470 and the rendered image 430, and a second loss function may be determined based on a visibility map 480 and the pixel error between a second warped image 490 and an input image 450.

For example, the first warped image 470 of the target view may be obtained through forward warping of the input image 450 of the source view, and the NSR model 420 may be trained based on the pixel error between the estimated pixel value of the rendered image 430 and the actual pixel value of the first warped image 470. Pixel errors between the first warped image 470 and the rendered image 430 may be iteratively calculated, and the NSR model 420 may be iteratively trained based on the pixel errors. Loss values of the first loss function may be determined according to the pixel errors, and the NSR model 420 may be trained in a direction in which the loss values decrease.

Furthermore, the second warped image 490 of the source view may be obtained through backward warping based on the rendered image 430 and an input depth map 460 of the source view, and the visibility map 480 may be obtained using the rendering depth map 440 according to Equations 3 to 5. The NSR model 420 may be trained based on the visibility map 480 and the pixel error between the second warped image 490 and the input image 450. Loss values of the second loss function may be determined according to the pixel errors, and the NSR model 420 may be trained in a direction in which the loss values decrease.

Finally, a loss function for training the NSR model 420 may be expressed as Equation 6.

$${ℒ}_{app} = \frac{1}{ν} {\sum }_{r ∈ ℛ} {‖ v ( r ) \cdot ( C ( π ( r ; {D}_{i} , {T}_{i \to j} ) ) - C ( r ) ) ‖}_{1} \\ ν = {\sum }_{r ∈ ℛ} v ( r ) \qquad [ Equation 6 ]$$

In Equation 6, x denotes a warping operation, C denotes the RGB value of the target view, and C denotes the RGB value of the source view.

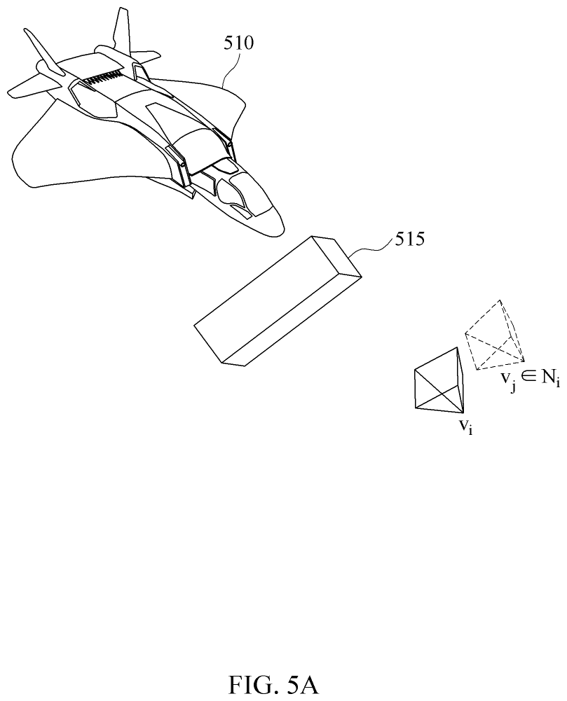

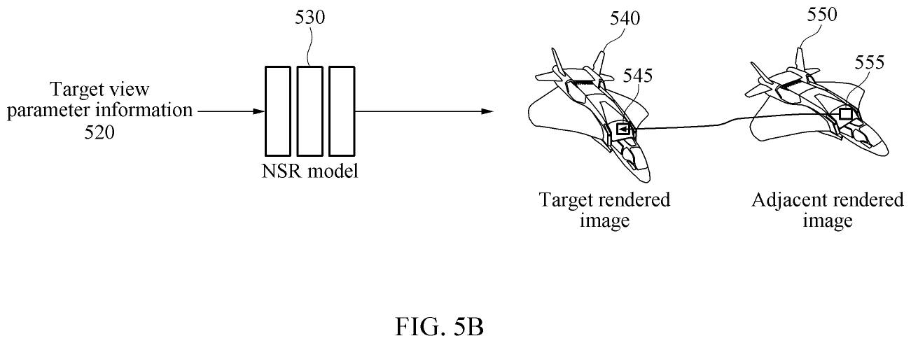

FIGS. 5A and 5B are diagrams illustrating a rendering method according to an embodiment. The description provided with reference to FIGS. 1 to 4 may also apply to FIGS. 5A and 5B.

Referring to FIG. 5A, a rendering device according to an embodiment may perform image rendering using a trained NSR model (e.g., the NSR model 420 of FIG. 4). The rendering device may, through a visibility map obtained using the relationship between the two views vᵢ, vⱼ and a rendered image of an adjacent view vⱼ (hereinafter referred to as an adjacent rendered image) based on a rendered image of a target view vᵢ (hereinafter referred to as the target rendered image), detect an area with poor image quality in the target rendered image and correct the area using the adjacent rendered image.

For example, the rendering device may render a target image corresponding to the target view vᵢ using an NSR model trained with a scene representation of an airplane object 510 in a 3D space. However, due to an obstacle 515, an occlusion area may occur in the target image corresponding to the target view vᵢ and accordingly, the image quality of the rendered target image may deteriorate. Thus, the rendering device may additionally render an adjacent image corresponding to the adjacent view vⱼ and correct the rendered target image using the rendered adjacent image, thereby improving the image quality of the rendered target image.

For example, referring to FIG. 5B, the rendering device may input target view parameter information 520 to a trained NSR model 530 to obtain a target rendered image 540 corresponding to the target view vᵢ.

Furthermore, the rendering device may determine the adjacent view vⱼ that satisfies a condition with respect to the target view vᵢ and may input parameter information corresponding to the adjacent view vⱼ to the trained NSR model 530 to obtain an adjacent rendered image 550 corresponding to the adjacent view vⱼ.

The rendering device may detect an occlusion area 545 of the target rendered image 540 and correct the occlusion area 545 of the target rendered image 540 based on the adjacent rendered image 550. The rendering device may obtain a visibility map based on the target rendered image 540 and the adjacent rendered image 550 and may correct the target rendered image 540 based on the visibility map.

A large visibility value may indicate a long distance between the target view vᵢ and the adjacent view vⱼ of the corresponding pixel and may thus indicate that the probability of the area being an occlusion area is high. The rendering device may detect an occluded pixel having a visibility value that is greater than or equal to a threshold value in the target image 540. The threshold may be a preset value. An occluded pixel may refer to a pixel included in an occlusion area. The rendering device may replace the occluded pixel of the occlusion area 545 of the target image 540 with a pixel of an area 555 of the adjacent rendered image 550 corresponding to the occlusion area 545. Accordingly, the rendering device may improve neural rendering performance through occlusion area-based image warping.

However, the method of correcting the target image 540 is not limited to the above-described examples. For example, the description provided with reference to FIG. 5B is based on correcting the target image 540 based on one adjacent view and one adjacent image corresponding to the one adjacent view, but the rendering device may correct the target image 540 based on a plurality of adjacent views and a plurality of adjacent images corresponding to the plurality of adjacent views. Moreover, the disclosure is not limited to a method of correcting the target image 540 based on the occluded area. As such, according to another embodiment, the target image 540 may be corrected or modified based on the visibility map in other scenarios in which an area of the target image 540 has an error.

The rendering device may determine a plurality of adjacent views that satisfies a condition with respect to a target view. For example, the rendering device may determine an adjacent view by sampling views within a preset camera rotation angle based on the target view. However, the disclosure is not limited thereto, and as such, according to another embodiment the conditions may be different from the camera rotation angle.

The rendering device may determine a pixel of each of the plurality of adjacent images corresponding to a position of the occluded pixel in the target image 540 and correct the occluded pixel in the target image 540 based on the pixel of each of the plurality of adjacent images. For example, the rendering device may determine “n” adjacent images (“n” is a natural number) having the highest visibility value among the plurality of adjacent images and may correct the occluded pixel in the target image 540 based on the determined “n” adjacent images. Alternatively, the rendering device may also correct the occluded pixel in the target image 540 based on statistical values of pixels of the plurality of adjacent images corresponding to the occluded pixel. The statistical values may include, but is not limited to, an average value, a weighted sum, etc.

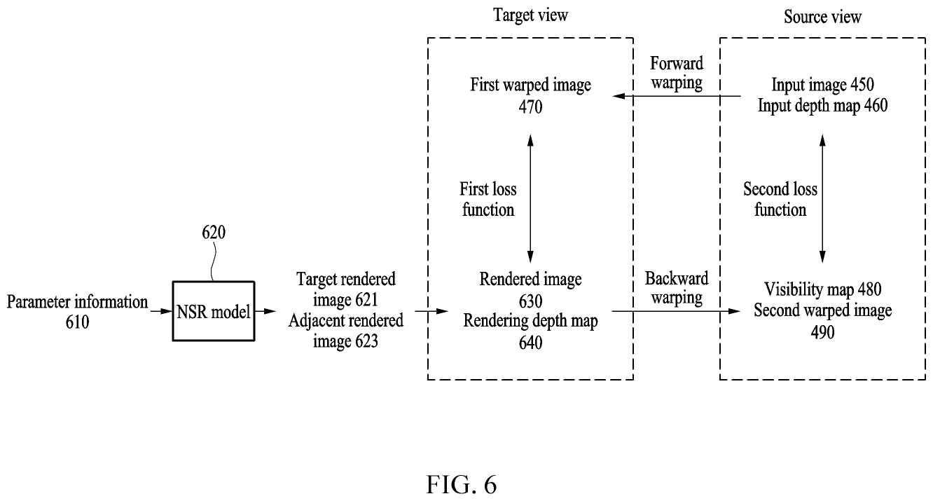

FIG. 6 is a diagram illustrating a method of training an NSR model, according to another embodiment.

Referring to FIG. 6, the description provided with reference to FIG. 4 may also apply to FIG. 6. However, the method of obtaining a rendered image 630 and a rendering depth map 640 shown in FIG. 6 may be different from the method of obtaining the rendered image 430 and the rendering depth map 440 in FIG. 4.

For example, an NSR model 620 may receive parameter information 610 and output a target rendered image 621 and an adjacent rendered image 623. The NSR model 620 may determine an adjacent view that satisfies a predetermined condition with respect to a target view and may additionally obtain an adjacent rendered image 623 corresponding to the adjacent view. The rendered image 630 and the rendering depth map 640 may be obtained through correction of the target rendered image 621 using the adjacent rendered image 623.

Since training of the NSR model 620 is performed based on a corrected image, the training quality of the NSR model 620 may be better than that of the NSR model 420 of FIG. 4.

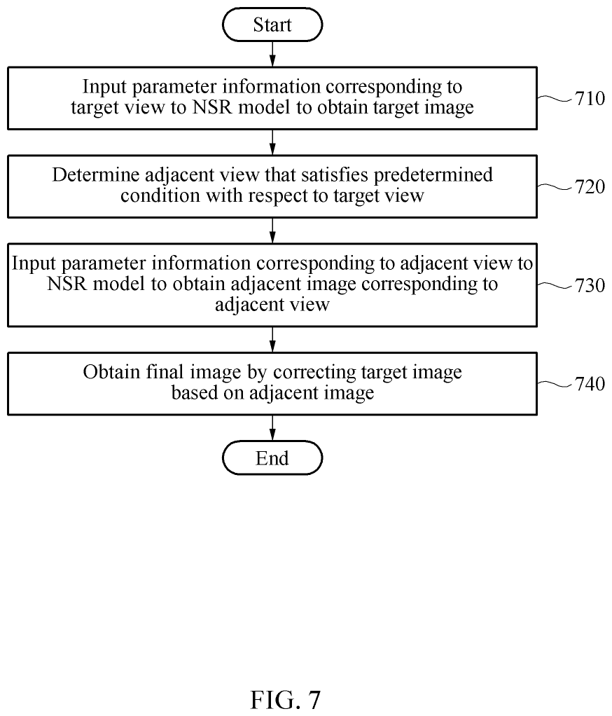

FIG. 7 is a flowchart illustrating a rendering method according to an embodiment.

For ease of description, it will be described that operations 710 to 740 are performed using the rendering device described with reference to FIG. 3. However, operations 710 to 740 may be performed by another suitable electronic apparatus in a suitable system.

Furthermore, the operations of FIG. 7 may be performed in the shown order and manner. However, the order of some operations may be changed, some other operations may be added, or some operations may be omitted without departing from the spirit and scope of the shown example. The operations shown in FIG. 7 may be performed in parallel or simultaneously.

Referring to FIG. 7, in operation 710, the method according to an embodiment includes inputting parameter information corresponding to a target view to an NSR model to obtain a target image corresponding to the target view. For example, the rendering device may input parameter information corresponding to a target view to an NSR model to obtain a target image corresponding to the target view. The target image may include a rendered image corresponding to the target view and a depth map corresponding to the target view. The depth map corresponding to the target view may be used to generate a weight map.

In operation 720, the method according to an embodiment includes obtaining an adjacent view that satisfies a condition with respect to the target view. For example, the rendering device may determine an adjacent view that satisfies a predetermined condition with respect to a target view. The rendering device may determine an adjacent view by sampling views within a preset camera rotation angle based on the target view. However, the method of determining an adjacent view is not limited to the above-described method, and various methods may be adopted.

In operation 730, the method according to an embodiment includes inputting parameter information corresponding to the adjacent view to the NSR model to obtain an adjacent image corresponding to the adjacent view. For example, the rendering device may input parameter information corresponding to the adjacent view to the NSR model to obtain an adjacent image corresponding to the adjacent view. The adjacent image may include a rendered image corresponding to the adjacent view and a depth map corresponding to the adjacent view.

In operation 740, the method according to an embodiment includes obtaining a final image by correcting the target image based on the adjacent image. For example, the rendering device may obtain a final image by correcting the target image based on the adjacent image. For example, the rendering device may detect an occlusion area of the target image and correct the occlusion area of the target image based on the adjacent image.

The rendering device may obtain a visibility map based on the target image and the adjacent image and correct the target image based on the visibility map. The rendering device may obtain an image warped to the target view by backward-warping the adjacent image to the target view and obtain the visibility map based on the difference between the image warped to the target view and the target image. The rendering device may determine a visibility value corresponding to the first pixel in proportion to the difference between a first pixel of the image warped to the target view and a second pixel of the target image corresponding to the first pixel.

The rendering device may detect an occlusion area based on the visibility map and correct the occlusion area of the target image based on the adjacent image. The rendering device may detect an occluded pixel having a visibility value that is greater than or equal to a preset threshold value in the target image. The rendering device may replace the occluded pixel in the target image with a pixel of the adjacent image corresponding to the position of the occluded pixel.

The rendering device may determine a plurality of adjacent views that satisfies a predetermined condition with respect to the target view, obtain a plurality of adjacent images corresponding to each of the plurality of adjacent views, determine a pixel of each of the plurality of adjacent images corresponding to a position of the occluded pixel in the target image, and correct the occluded pixel in the target image based on the pixel of each of the plurality of adjacent images.

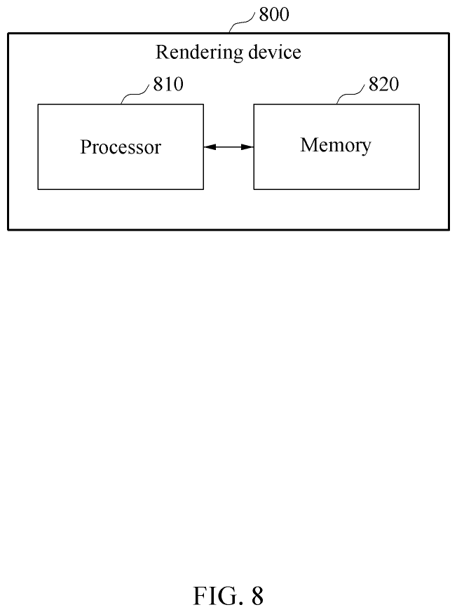

FIG. 8 is a block diagram illustrating an example of a configuration of a rendering device according to an embodiment.

Referring to FIG. 8, a rendering device 800 may include a processor 810 and a memory 820. The memory 820 may be connected to the processor 810 and may store instructions executable by the processor 810, data to be computed by the processor 810, or data processed by the processor 810. The memory 820 may include a non-transitory computer-readable medium and/or a non-volatile computer-readable storage medium. For example, the non-transitory computer-readable medium may include, but is not limited to, a high-speed random-access memory, and the non-volatile computer-readable storage medium may include, but is not limited to, at least one disk storage device, flash memory device, or other non-volatile solid state memory devices.

The processor 810 may execute the instructions (stored in the memory 820) to perform the operations described above with reference to FIGS. 5A, 5B, and 7. For example, the processor 810 may obtain a target image corresponding to a target view by inputting parameter information corresponding to the target view to an NSR model, determine an adjacent view that satisfies a condition with respect to a target view, obtain an adjacent image corresponding to the adjacent view by inputting parameter information corresponding to the adjacent view to the NSR model, and obtain a final image by correcting the target image based on the adjacent image. In addition, the description provided with reference to FIGS. 5A, 5B, and 7 may apply to the rendering device 800.

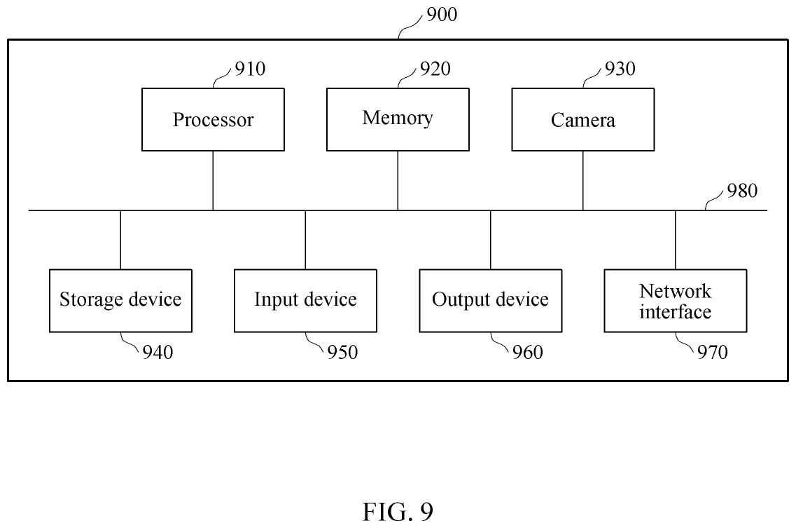

FIG. 9 is a block diagram illustrating an example of a configuration of an electronic device, according to an embodiment.

Referring to FIG. 9, an electronic device 900 may include a processor 910, a memory 920, a camera 930, a storage device 940, an input device 950, an output device 960, and a network interface 970. The components of the electronic device 900 may communicate with each other through a communication bus 980. The electronic device 900 is not limited to the components illustrated in FIG. 9, and as such, according to another embodiment, one or more components may be added, omitted or combined. For example, the electronic device 900 may be embodied as at least a portion of a mobile device (e.g., a mobile phone, a smartphone, a personal digital assistant (PDA), a netbook, a tablet computer, a laptop computer, etc.), a wearable device (e.g., a smartwatch, a smart band, smart eyeglasses, etc.), a computing device (e.g., a desktop, a server, etc.), a home appliance (e.g., a television (TV), a smart TV, a refrigerator, etc.), a security device (e.g., a door lock, etc.), or a vehicle (e.g., an autonomous vehicle, a smart vehicle, etc.). The electronic device 900 may include, structurally and/or functionally, the rendering device 800 of FIG. 8.

The processor 910 may execute one or more software codes, functions and/or instructions to control or perform operations of the electronic device 900. For example, the processor 910 may process instructions stored in the memory 920 or the storage device 940. The processor 910 may perform the operations described with reference to FIGS. 1 to 8. The memory 920 may include a non-transitory computer-readable storage medium or a non-transitory computer-readable storage device. The memory 920 may store instructions that are to be executed by the processor 910 and may also store information associated with software and/or applications when the software and/or applications are being executed by the electronic device 900.

The camera 930 may capture a photo and/or a video. The storage device 940 may include a non-transitory computer-readable storage medium or a non-transitory computer-readable storage device. The storage device 940 may store a greater amount of information than the memory 920. Moreover, the storage device 940 may store the information for a long period of time than the memory 920. For example, the storage device 940 may include magnetic hard disks, optical disks, flash memories, floppy disks, or other forms of non-volatile memories known in the art.

The input device 950 may receive an input from a user through a traditional input scheme using a keyboard and a mouse, and through a new input scheme such as a touch input, a voice input and an image input. For example, the input device 950 may detect an input from a keyboard, a mouse, a touchscreen, a microphone, or a user, and may include any other device configured to transfer the detected input to the electronic device 900. The output device 960 may provide a user with an output of the electronic device 900 through a visual channel, an auditory channel, or a tactile channel. The output device 960 may include, for example, a display, a touchscreen, a speaker, a vibration generator, or any other device configured to provide a user with the output of the electronic device 900. The network interface 970 may communicate with an external device via a wired or wireless network.

The embodiments described herein may be implemented using a hardware component, a software component, and/or a combination thereof. For example, a processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the processing device is described as singular. However, one of ordinary skill in the art will appreciate that a processing device may include multiple processing elements and/or multiple types of processing elements. For example, the processing device may include a plurality of processors, or a single processor and a single controller. In addition, different processing configurations are possible, such as parallel processors.

Software may include a computer program, a piece of code, an instruction, or combinations thereof, to independently or collectively instruct or configure the processing device to operate as desired. Software and/or data may be embodied permanently or temporarily in any type of machine, component, physical or virtual equipment, computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the purposes of examples, or they may be of the kind well-known and available to one of ordinary skill in the computer software arts. Examples of non-transitory computer-readable media include magnetic media such as hard disks, floppy disks, and magnetic tape; optical media such as CD-ROM discs and DVDs; magneto-optical media such as optical disks; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter.

While the embodiments are described with reference to a limited number of drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A rendering method comprising:
obtaining a target image corresponding to a target view based on by inputting first parameter information corresponding to the target view to a neural scene representation (NSR) model;
obtaining an adjacent view that satisfies a predetermined condition with respect to the target view;
obtaining an adjacent image corresponding to the adjacent view by inputting second parameter information corresponding to the adjacent view to the NSR model; and
obtaining a final image by correcting the target image based on the adjacent image.

2. The rendering method of claim 1, wherein the obtaining the final image comprises:
detecting an occlusion area in the target image; and
correcting the occlusion area in the target image based on the adjacent image.

3. The rendering method of claim 1, wherein the obtaining the final image comprises:
obtaining a visibility map based on the target image and the adjacent image; and
correcting the target image based on the visibility map.

4. The rendering method of claim 3, wherein the obtaining the visibility map comprises:
obtaining a first warped image by backward-warping the adjacent image to the target view; and
obtaining the visibility map based on a difference between the first warped image and the target image.

5. The rendering method of claim 4, wherein the obtaining the visibility map based on the difference comprises:
obtaining a visibility value for a first pixel of the first warped image based on a difference between the first pixel of the first warped image and a second pixel of the target image corresponding to the first pixel.

6. The rendering method of claim 3, wherein the correcting the target image comprises:
detecting an occlusion area in the target image based on the visibility map; and
correcting the occlusion area in the target image based on the adjacent image.

7. The rendering method of claim 6, wherein the detecting the occlusion area comprises:
detecting an occluded pixel having a visibility value that is greater than or equal to a threshold value in the target image.

8. The rendering method of claim 7, wherein the correcting the occlusion area comprises:
replacing the occluded pixel in the target image with a pixel of the adjacent image corresponding to a position of the occluded pixel.

9. The rendering method of claim 7,
wherein the obtaining the adjacent view comprises:
obtaining a plurality of adjacent views corresponding to the target view, wherein the obtaining of the adjacent image comprises:
obtaining a plurality of adjacent images, each of the plurality of adjacent images corresponding to one of the plurality of adjacent views, and
wherein the correcting of the occlusion area comprises:
obtaining a pixel of each of the plurality of adjacent images corresponding to a position of the occluded pixel in the target image; and
correcting the occluded pixel in the target image based on the pixel of each of the plurality of adjacent images.

10. The rendering method of claim 1, wherein the obtaining the adjacent view comprises:
obtaining the adjacent view by sampling views within a preset camera rotation angle based on the target view.

11. The rendering method of claim 1, wherein the obtaining the target image comprises:
obtaining a rendered image corresponding to the target view and a depth map corresponding to the target view.

12. The rendering method of claim 1, wherein the obtaining the adjacent image comprises:
obtaining a rendered image corresponding to the adjacent view and a depth map corresponding to the adjacent view.

13. A non-transitory computer-readable storage medium storing instructions that, when executed by a processor, cause the processor to perform a method comprising:
obtaining a target image corresponding to a target view by inputting first parameter information corresponding to the target view to a neural scene representation (NSR) model;
obtaining an adjacent view corresponding to the target view;
obtaining an adjacent image corresponding to the adjacent view by inputting second parameter information corresponding to the adjacent view to the NSR model; and
obtaining a final image by correcting the target image based on the adjacent image.

14. A rendering device comprising:
a memory configured to store instructions,
at least one processor configured to execute the instructions to:
obtain a target image corresponding to a target view by inputting first parameter information corresponding to the target view to a neural scene representation (NSR) model;
obtain an adjacent view that satisfies a predetermined condition with respect to the target view;
obtain an adjacent image corresponding to the adjacent view by inputting second parameter information corresponding to the adjacent view to the NSR model; and
obtain a final image by correcting the target image based on the adjacent image.

15. The rendering device of claim 14, wherein the at least one processor is further configured to execute the instructions to:
detect an occlusion area in the target image; and
correct the occlusion area in the target image based on the adjacent image.

16. The rendering device of claim 14, wherein the at least one processor is further configured to execute the instructions to:
obtain a visibility map based on the target image and the adjacent image; and
correct the target image based on the visibility map.

17. The rendering device of claim 16, wherein the at least one processor is further configured to execute the instructions to:
obtain a first warped image by backward-warping the adjacent image to the target view; and
obtain the visibility map based on a difference between the first warped image and the target image.

18. The rendering device of claim 15, wherein the at least one processor is further configured to execute the instructions to:
detect an occlusion area in the target image based on the visibility map; and
correct the occlusion area in the target image based on the adjacent image.

19. The rendering device of claim 18, wherein the at least one processor is further configured to execute the instructions to:
detect an occluded pixel having a visibility value that is greater than or equal to a threshold value in the target image.

20. The rendering device of claim 19, wherein the at least one processor is further configured to execute the instructions to:
replace the occluded pixel in the target image with a pixel of the adjacent image corresponding to a position of the occluded pixel.
